(19) United States
(12) Patent Application Publication
(10) Pub. No.: US 2013/0238607 A1
(43) Pub. Date: Sep. 12, 2013

(54) SEED SET EXPANSION

(71) Applicants: Cong-Lei Yao, Beijing (CN); Yuhong Xiong, Mountain View, CA (US); Li-Wei Zheng, Beijing (CN)

(72) Inventors: Cong-Lei Yao, Beijing (CN); Yuhong Xiong, Mountain View, CA (US); Li-Wei Zheng, Beijing (CN)

(21) Appl. No.: 13/883,934

(22) PCT Filed: Nov. 10, 2010
(86) PCT No.: PCT/CN10/78595

§ 371 Date: May 7, 2013

(51) Int. Cl. G06F 17/30

(52) U.S. Cl. CPC G06F 17/30442
USPC 707/722

(57) ABSTRACT

Systems and methods for seed set expansion are provided. A context-based extractor (22) generates a set of context-based candidate members of a seed set from a set of web pages associated with an organization as words connected with a seed set member by a contextual pattern and a context confidence value for each candidate member. A list-based extractor (24) generates a set of list-based candidate members from elements within a plurality of lists in the set of web pages and a list confidence value associated with each candidate member. A confidence arbitrator (26) determines an intersection set of candidate members present in both sets of candidate members and determines a final confidence value for each of the intersection set of candidate members based on their respective context confidence value and list confidence value. A candidate selector (28) selects a candidate member for inclusion in a seed set (21).

### TECHNICAL FIELD

This invention relates to information processing, and more particularly, to seed set expansion.

### BACKGROUND

The Internet contains large amounts of information in unstructured or semi-structured form. Information extraction processes allow information contained within web pages to be made accessible, or at least more accessible, for machine processing. One use for information extraction processes might be analyzing a set of documents written in a natural language and populate a database with the information extracted.

### BRIEF DESCRIPTION OF THE DRAWINGS

FIG. 1 illustrates an example of a system for expanding a seed set comprising a list of members of a class of named entities within a set of web pages associated with an organization.

FIG. 2 illustrates an example method for expanding a seed set representing a class of named entities within a set of web pages associated with an organization.

FIG. 3 illustrates a functional block diagram of an example system for identifying candidate members of a class of named entities within a plurality of lists within a set of web pages associated with an organization.

FIG. 4 illustrates a functional block diagram of another example system for identifying candidate members of a class of named entities within a plurality of lists within a set of web pages associated with an organization.

### DETAILED DESCRIPTION

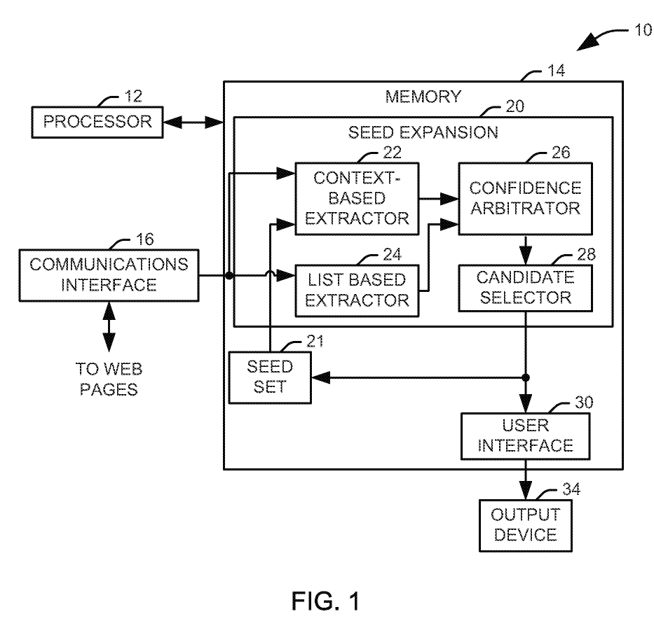

FIG. 1 illustrates an example of a system 10 for expanding a seed set. The seed set can comprise a list of members of a class of named entities within a set of web pages associated with an organization. For instance, the web pages associated with the organization can be an internal network that provides a large scale, low-quality corpus that does not have the added redundancy of a web-scale corpus. The system 10 includes a processor 12 and a memory 14 connected to a communications interface 16. The communication interface 16 can comprise any appropriate hardware and machine readable instructions for accessing the set of web pages, such as may be associated with an organization (e.g., a business, an institution). For example, the communications interface 16 can include any or all of a bus or similar data connection within a computer system, a wired or wireless network adapter, and equipment for reading storage media containing the set of web pages. The memory 14 can include any appropriate standard storage device associated with computer systems, such as any number of magnetic, semiconductor and optical storage media.

The memory 14 can include a seed expansion component 20 to determine new members for a seed set 21 comprising a list of members of a class of named entities from the set of web pages associated with an organization. For example, the seed expansion component 20 can include a context-based extractor 22 to generate a set of context-based candidate members of the class of named entities as words found to be connected with an element from the seed set 21 via a contextual pattern. For example, contextual patterns signifying a relationship between two words can be determined from the set of web pages (e.g., obtained via the communications interface) and the seed set 21, and words connected to a member of the seed set by one of the determined patterns can be selected as candidate members. Each selected candidate member is then assigned a context confidence value. For example, the context confidence value can be assigned according to a confidence associated with the contextual pattern, with contextual patterns that occur frequently with semantically related word pairs within the set of web pages and infrequently with unrelated word pairs having a high confidence.

The seed expansion component 20 further comprises a list-based extractor 24 to generate a set of list-based candidate members from elements within lists found within the set of web pages. For example, the list-based extractor 24 can locate tags in a markup language, such as hypertext markup language (HTML), indicative of a list, and the elements of each list can be extracted. From these elements, the list-based extractor 24 can determine a set of list-based candidate members of the class of named entities. The list-based extractor 24 then determines a list confidence value for each candidate member. For example, the list confidence value for a given candidate can be assigned according to a confidence associated with a list or lists from which the candidate was extracted. The confidence associated with each list can be determined according to its degree of overlap in elements with other lists from the set of web pages.

A confidence arbitrator 26 receives the set of context-based candidate members from the context-based extractor 22 and the set of list-based candidate members from the list-based extractor 24 as well as their respective associated confidence values. The confidence arbitrator 26 determines an intersection set of candidate members that are present in both sets of candidate members. The confidence arbitrator 26 also determines a final confidence value for each of the intersection set of new candidate members. For example, the confidence arbitrator 26 can calculate the final confidence value for each new candidate member as a weighted linear combination of the confidence values or selected as one of the confidence values from the input sets of candidate members. In one example implementation, the lesser value of the two confidence values is selected as the final confidence value.

The various candidate members and confidence values can then be provided to a candidate selector 28. The candidate selector 28 is programmed to select candidates for inclusion in the class of named entities according to their arbitrated confidence values. For example, the candidate selector 28 can select a predetermined number of highest ranked candidates in an ordinal ranking by confidence value or the candidate selector 28 can select all candidates having a confidence value greater than a threshold value for addition to the seed set 21. Once the candidate selector 28 has selected additions to the seed set, they can be provided to a user through a user interface 32 at an associated output device (e.g., including a display) 34.

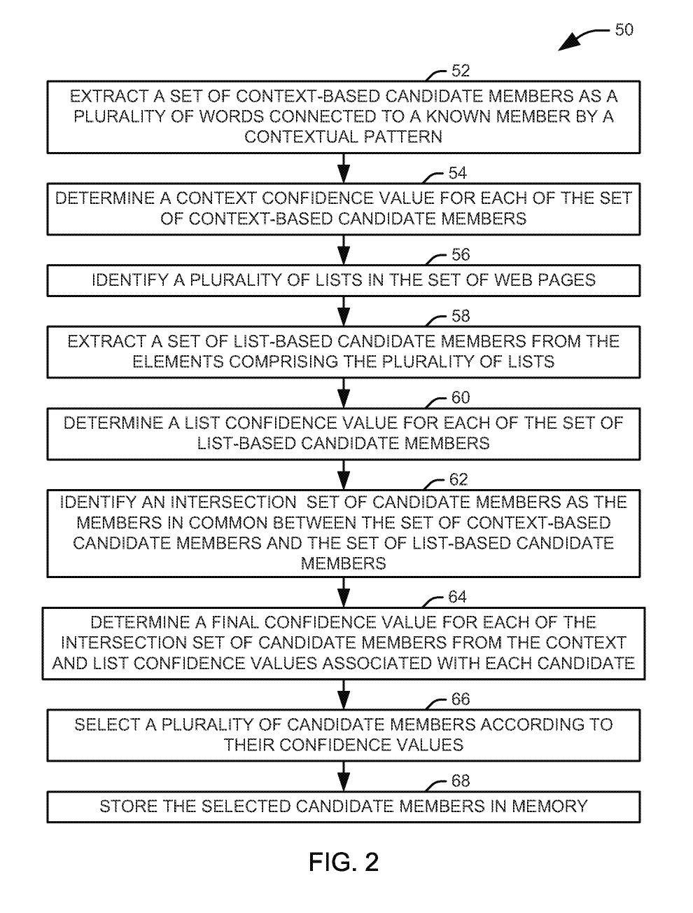

FIG. 2 illustrates an example methodology 50 for expanding a seed set representing a class of named entities within a set of web pages associated with an organization. It is to be understood and appreciated that the illustrated actions, may occur in different orders and/or concurrently with other actions. Moreover, not all illustrated features may be required to implement the method.

At 52, a set of context-based candidate members of the class of named entities are extracted as words in the set of web pages that are connected with one of a set of known members of the class via a contextual pattern. For example, a plurality of contextual patterns that signify a relationship between two words can be determined from the set of web pages and the set of known members. Words connected to one of the set of known members by one of the determined patterns can be selected as candidate members. At 54, a context confidence value is determined for each of the set of context-based candidates. In one example implementation, the context confidence value can be assigned to a given candidate according to a confidence associated with the contextual pattern used to select the candidate. For example, contextual patterns that occur frequently with semantically related word pairs within the set of web pages and infrequently with unrelated word pairs will have a high confidence

At 56, a plurality of lists, each having a plurality of elements, are identified within the set of web pages. For example, tags (e.g., <TD> and <LI>) in hypertext markup language (HTML) indicative of a list can be located, and the elements of the list can be extracted. At 58, a set of list-based candidate members of the class of named entities are extracted from the elements comprising the plurality of lists. At 60, a list confidence value is determined for each of the set of list-based candidate members. For example, the list confidence value for a given candidate can be assigned according to a confidence associated with a list or lists from which the candidate was extracted, with the confidence associated with each list can be determined according to its degree of overlap in elements with other lists from the set of web pages.

At 62, an intersection set of candidates are identified as those words that that are common to the set of context candidates and the set of list-based candidates. At 64, a final confidence value is determined for each of the intersection set of candidate members from the context confidence value and the list confidence value associated with the member. Any appropriate method for arbitrating between the confidence values can be used, including taking a weighted linear combination of the confidence values or selecting one of the context or list confidence values. In an example implementation, the lesser value of the two confidence values is selected as the final confidence value to reduce the likelihood of false positives.

At 66, a plurality of candidates are selected for inclusion in the class of named entities according to their associated confidence values. The selected candidates can be drawn from the context-based set of candidates, the list-based set of candidates, and the intersection set. For example, a predetermined number of highest ranked candidates in an ordinal ranking by confidence value can be selected. In an example implementation, all candidates having a confidence value greater than a threshold value can be selected for addition to the class and stored in memory. The selected candidates are stored in memory at 68. The selected members can then be displayed to a user at an associated output device or used by another application.

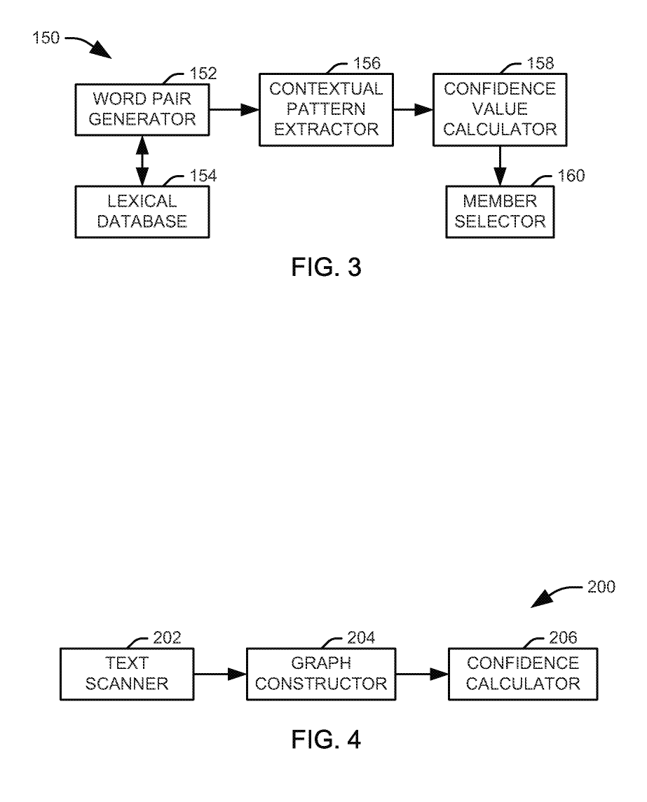

FIG. 3 illustrates a functional block diagram of an example system 150 for identifying candidate members of a class of named entities within a plurality of lists contained in a set of web pages associated with an organization. It will be understood that each of the various elements 152, 154, 156, 158, and 160 of the illustrated system 150 can be implemented as dedicated hardware, machine readable instructions stored on an appropriate storage medium, or some combination of hardware and machine readable instructions.

The system 150 comprises a word pair generation component 152 to generate word pairs from an associated lexical database 154. One example of the lexical database 154 that can be used for this purpose for the English language is WordNet, and similar lexical databases exist for other languages. The word pair generator 152 can generate a set of word pairs comprising semantically related word pairs and a set of word pairs, comprising unrelated word pairs. For example, each the set of related word pairs can be selected to be synonymous and each of the set of unrelated words can be randomly selected by the word pair generation component 152.

The sets of word pairs are provided to a contextual pattern extractor 156. The contextual pattern extractor 156 is programmed to evaluate the set of web pages associated with the organization to determine contextual patterns within the web pages that signify that two words are semantically related. To this end, each word pair can be used as a query on the set of web pages, and the contextual pattern extractor 156 extracts a plurality of word strings containing both words in the word pair. In an example implementation, the contextual pattern extractor 156 can limit the length of the word strings to a predetermined number of words, such as strings of three, four, or five words. Each word string, or more specifically the words other than the queried word pair within the word string, can be evaluated as a candidate pattern connecting the queried word pair. Accordingly, the contextual pattern extractor 156 produces a set of candidate patterns for each of the set of related word pairs and the set of unrelated word pairs.

The sets of candidate patterns are then provided to a confidence value calculator 158 to provide a confidence value for each candidate pattern. To this end, a number of occurrences of a given candidate pattern connecting a word pair in the set of related word pairs can be compared to a number of occurrences of the candidate pattern connecting a word pair in the set of unrelated word pairs. Based on this comparison, an appropriate confidence value for the pattern can be determined, representing the likelihood that a pair of words connected by the pattern are semantically related. In one example, the confidence value is determined by calculating a chi-squared value for a pattern according to its occurrence with related and non-related word pairs, such that:

$${χ}_{j}^{2} = \frac{{( R + N ) [ {r}_{j} ( N - {n}_{j} ) - {n}_{j} ( R - {r}_{j} ) ]}^{2}}{RN ( {r}_{j} + {n}_{j} ) ( R + N - {r}_{j} - {n}_{j} )} \qquad Eq . 1$$

where R is the total number of occurrences across all patterns in which a pattern connects related word pairs,
N is the total number of occurrences across all patterns in which a pattern connects unrelated word pairs,
rⱼ is the number of occurrences in which a pattern, j, connects related word pairs, and
nⱼ is the number of occurrences in which the pattern connects unrelated word pairs.

The confidence value calculator 158 can determine a confidence for each candidate pattern for each pattern by comparing its associated chi-squared value to an appropriate chi-squared distribution. A set of candidate patterns are then selected for use as contextual patterns for locating members of the class of named entities. For example, a predetermined number of highest ranked candidate patterns in an ordinal ranking by confidence can be selected. Alternatively, all candidate patterns having a confidence value greater than a threshold value can be selected.

The selected contextual patterns are provided to a member selector 160 that scans the set of web pages associated with the organization to identify a set of candidate members. For example, the member selector 160 can locate each occurrence of the selected contextual patterns in the web pages in conjunction with a known member of the class of named entities, and a word connected to the known member by the contextual pattern can be extracted as a candidate class member. For each candidate class member, a confidence value can be determined for the element according to the contextual pattern or patterns that connect the element to one of the known members. For example, the candidate member can be assigned the confidence value associated with the contextual pattern connecting it to a known member.

Where the candidate member is found to be connected with a known class member, by multiple patterns, the confidence values associated with the various contextual patterns can be arbitrated by an appropriate method. For instance, the confidence value arbitration can include taking a weighted linear combination of the confidence values or selecting one of the confidence values of the candidate members being arbitrated. In one implementation, the largest confidence value from the confidence values associated with the contextual patterns can be selected. The set of candidate members and their associated confidence values can then be recorded in memory for further analysis.

FIG. 4 illustrates a functional block diagram of another example system 200 for identifying candidate members of a class of named entities within a plurality of lists within a set of web pages associated with an organization. It will be appreciated that each of the various elements 202, 204, and 206 of the illustrated system 200 can be implemented as dedicated hardware, machine readable instructions stored on an appropriate storage medium, or some combination of hardware and machine readable instructions. The system 200 includes a text scanner 202 programmed to locate a plurality of lists in the set of web pages. For example, the text scanner 202 can review each of the web pages for hypertext markup language (HTML) tags related to lists and tables (e.g., <TD> and <LI>) and extract the elements in each individual column of a given list or table as a separate list.

The extracted lists are then provided to a graph constructor 204 to construct a weighted directed graph in which each node represents one of the extracted lists. The nodes for each pair of lists containing at least two common elements are connected by two edges, with each edge having a corresponding weight representing a degree of overlap between elements of the lists represented by the two nodes connected by the edge. It will be appreciated that edges are directional, such that a first edge connecting a first node to a second node can have a different weight than a second edge connecting the second node to the first node. In one implementation, the weight, wᵢⱼ, connecting for an edge connecting a first node, i, and a second node, j, can be calculated as:

$${w}_{i , j} = \frac{C ( {v}_{i ⋂ j} )}{C ( {v}_{i} )} \qquad Eq . 2$$

where vᵢ is the number of elements in the list associated with node i,
v_{i∩j} is the number of elements common to the lists associated with nodes i and j, and

C(n)=n*(n−1)/2.

A confidence calculator 206 processes the completed graph to calculate a confidence value for each list representing the likelihood that all of the elements on the list belong to a same class of entities. By way of example, a transition matrix can be used to calculate a normalized confidence for each list, with the transition matrix, T, being populated with each element, T_{i,j}, where T_{i,j} can be expressed as follows:

$${T}_{i , j} = \frac{{w}_{j , i}}{{\sum }_{k = 1}^{n} {w}_{j , k}} ,$$

if the graph contains an edge, w_{j,1}

T_{i,j}=0 otherwise.

Once the matrix is constructed, the transition matrix can be used to calculate raw confidence values via an iterative method. For example, the process begins with a set of initial raw confidence values for the n nodes provided as a n-element vector, t₀, with each initial confidence value equal to 1/n. The initial confidence values are then iteratively refined using the transition matrix T, with each successive iteration being calculated as:

tᵢ₊₁=α_{B}Ttᵢ+(1−α_{B})t₀ Eq. 3

where αₛ is a decay factor, set in one example to 0.85.

After a number of iterations, for example, twenty iterations, convergence can be achieved, and the resulting raw confidence values can be used to calculate a normalized confidence for each of the plurality of nodes. For a given set of raw confidence values, r₁−rₙ, a normalized confidence value, cᵢ, for each node can be calculated as:

$${c}_{i} = \frac{{r}_{i}}{max ( {r}_{1} - {r}_{n} )} \qquad Eq . 4$$

The normalized confidence for each node represents the likelihood that each element on that list belongs to the class of named entities given that a known member of the class appears on the list. Accordingly, given an initial seed set, containing known members of the class of named entities, a set of elements from the plurality of lists that occur on a same list as one of the known members can be determined as candidate members of the class of named entities. For each candidate member, a confidence value can be determined for the element according to the list or lists that connect the element to one of the known members. For example, the candidate member can be assigned the confidence value associated with the list upon which it appears with a known member.

Where the candidate member appears with a known class member on multiple lists, the confidence values associated with the various lists can be arbitrated by an appropriate method, including taking a weighted linear combination of the confidence values or selecting one of the confidence values. In one implementation, the largest confidence value from the multiple lists can be selected. The set of candidate members and their associated confidence values can be recorded for further analysis.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A non-transitory computer readable medium, storing machine readable instructions, the machine readable instructions comprising:
a context-based extractor (22) to generate a set of context-based candidate members of a class of named entities within a set of web pages associated with an organization as words found to be connected with a known member of the class via a contextual pattern and a context confidence value associated with each candidate member in the set of context-based candidate members;
a list-based extractor (24) to generate a set of list-based candidate members from elements within a plurality of lists in the set of web pages and a list confidence value associated with each candidate member in the set of list-based candidate members;
a confidence arbitrator (26) to determine an intersection set of candidate members present in each of the set of context-based candidate members and the set of list-based candidate members and determine a final confidence value for each of the intersection set of candidate members based on their respective context confidence value and list confidence value; and
a candidate selector (28) to select a candidate member from one of the set of context-based candidate members, the set of list-based candidate members, and the intersection set of candidate members for inclusion in a seed set (21).

2. The non-transitory computer readable medium of claim 1, wherein the confidence arbitrator (26) determines the final confidence value as the lesser of the context confidence value and the list confidence value.

3. The non-transitory computer readable medium of claim 1 or 2, wherein the confidence arbitrator (26) determines the final confidence value as a weighted linear combination of the context confidence value and the list confidence value.

4. The non-transitory computer readable medium of claim 1, 2 or 3, wherein the confidence arbitrator (26) selects the candidate member by comparing a confidence value associated with the candidate member to a threshold.

5. The non-transitory computer readable medium of claim 1, 2, 3, or 4, the context-based extractor comprising:
a word pair generator (152) to generate a plurality of semantically related word pairs and a plurality of unrelated word pairs;
a contextual pattern extractor (156) to:
search the set of web pages for occurrences of each of the plurality of semantically related word pairs and the plurality of unrelated word pairs,
extract word strings from the web pages containing both words in a given word pair, and
determine, from the extracted word strings, a plurality of contextual patterns indicating a semantic relationship between two words, each contextual pattern having a confidence value; and
a confidence value calculator (158) to provide a confidence value associated with each contextual pattern, indicating a likelihood that two words connected by the contextual pattern belong to a same class of entities; and

6. The non-transitory computer readable medium of claim 5, the context-based extractor further comprising:
a member selector (160) to:
search the set of web pages for occurrences a contextual pattern of the plurality of contextual patterns with an entity from the list of named entities,
extract word strings from the web pages, each word string containing the contextual pattern connecting the entity and a new word, and
assign the new word to the set of context-based candidate members with the list confidence value determined from the confidence value associated with the contextual pattern connecting the entity with the new word.

7. The non-transitory computer readable medium of claim 6, the member selector (160) assigning the new word to the set of context-based candidate members with the list confidence value associated with the new word equal to a confidence value associated with the contextual pattern connecting the new word to the entity.

8. The non-transitory computer readable medium of claim 5, 6, or 7, the confidence value calculator (158) providing the confidence value for the contextual pattern from a number of semantically related word pairs connected by the contextual pattern within the set of web pages and a number of unrelated word pairs connected by the contextual pattern within the set of web pages.

9. The non-transitory computer readable medium of claim 8, the confidence value calculator (158) calculating a chi-squared value from the number of semantically related word pairs connected by the contextual pattern within the set of web pages and the number of unrelated word pairs connected by the contextual pattern within the set of web pages and determining the confidence value according to an appropriate chi-squared distribution and the calculated chi-squared value.

10. The non-transitory computer readable medium of claim 1, 2, 3, 4, or 5, the list-based extractor comprising:
a text scanner (202) to locate a plurality of lists in the set of web pages;
a graph constructor (204) to construct a weighted directed graph comprising a plurality of nodes, each node representing a list of the plurality of lists, and the graph constructor to determine a weight between each pair of nodes representing an overlap in the elements between a first list of a given pair and the second list of the given pair; and
a confidence calculator (206) to calculate, from the weighted directed graph, a confidence value for each list representing a likelihood that, given that an element from the list belongs to the class of named entities, all of the elements in the list belong the class of named entities, and the confidence calculator to assign a context confidence value to a first element from the plurality of lists according to the confidence value associated with a list in which the first element appears.

11. The non-transitory computer readable medium of claim 10, the weighting being asymmetric such that a first weight representing the overlap between a first list and a second list is different than a second weight representing the overlap between the second list and the first list.

12. A system for expanding a seed set (21), the machine readable instructions comprising:
memory (14) storing machine readable instructions, the machine readable instructions comprising:
a context-based extractor (22) to generate a set of context-based candidate members of a class of named entities within a set of web pages associated with an organization as words found to be connected with a known member of the class via a contextual pattern and a context confidence value associated with each candidate member in the set of context-based candidate members;
a list-based extractor (24) to generate a set of list-based candidate members from elements within a plurality of lists in the set of web pages and a list confidence value associated with each candidate member in the set of list-based candidate members;
a confidence arbitrator (26) to determine an intersection set of candidate members present in each of the set of context-based candidate members and the set of list-based candidate members and determine a final confidence value for each of the intersection set of new candidate members according their associated context confidence value and list confidence value; and
a candidate selector (28) to select a candidate member from one of the set of context-based candidate members, the set of list-based candidate members, and the intersection set of candidate members for inclusion in the seed set (21);
a processor operatively connected to the memory to execute the machine readable instructions.

13. The system of claim 12, the list-based extractor (24) comprising:
a text scanner (202) to locate a plurality of lists in the set of web pages;
a graph constructor (204) to construct a weighted directed graph comprising a plurality of nodes, each node representing a list of the plurality of lists and to determine a weight between each pair of nodes representing an overlap in the elements between a first list of a given pair and the second list of the given pair; and
a confidence calculator (206) to calculate, from the weighted directed graph, a confidence value for each list representing a likelihood that, given that an element from the list belongs to the class of named entities, all of the elements in the list belong the class of named entities and to assign the list confidence value for a first element from the plurality of lists according to the confidence value associated with a list in which the first element appears.

14. A method for expanding a list of members of a class of named entities within a set of web pages associated with an organization comprising:
extracting a set of context-based candidate members of the class of named entities as words found to be connected with a known member of the class via a contextual pattern (52);
determining a context confidence value for each of the set of context-based candidate members according to a confidence value associated with the contextual pattern (54);
identifying a plurality of lists in the set of web pages, each list having a plurality of elements (56);
extracting a set of list-based candidate members of the class of named entities from elements comprising the plurality of lists (58);
determining a list confidence value for each of the set of list-based candidate members according to a confidence value associated with a list of the plurality of lists (60);
identify an intersection set of candidate members that are common to the set of context-based candidate members and the set of list-based candidate members (62);
determining a final confidence value for each of the intersection set of candidate members from the context confidence value and the list confidence value (64);
selecting a candidate member according to an associated confidence value thereof (66); and
storing the selected candidate member in memory (68).

15. The method of claim 14, wherein extracting the set of context-based candidate members (52) further comprises:
generating a plurality of semantically related word pairs;
generating a plurality of unrelated word pairs;
searching the set of web pages for occurrences of each of the plurality of semantically related word pairs and the plurality of unrelated word pairs;
extracting word strings from the web pages containing both words in a given word pair;
determining, from the extracted word strings, a plurality of contextual patterns indicating a semantic relationship between two words, each contextual pattern having a confidence value indicating the likelihood that two words connected by the contextual pattern belong to a same class of entities;
searching the set of web pages for occurrences of the plurality of contextual patterns and an entity from the list of named entities;
extracting word strings from the web pages, each word string containing a contextual pattern connecting the entity and a new word; and
assigning the new word to the set of list-based candidate members.
